(19) United States
(12) Patent Application Publication
(10) Pub. No.: US 2023/0284589 A1
(43) Pub. Date: Sep. 14, 2023

(54) HYGIENIC SLOW FEEDING BOWL

(71) Applicant: Joseph McCormick, Huntingburg, IN (US)

(72) Inventor: Joseph McCormick, Huntingburg, IN (US)

(21) Appl. No.: 18/198,395

(22) Filed: May 17, 2023

Related U.S. Application Data
(63) Continuation-in-part of application No. 17/225,028, filed on Apr. 7, 2021.

(51) Int. Cl. A01K 5/01

(52) U.S. Cl. CPC A01K 5/0114

(57) ABSTRACT

A hygienic slow feeding bowl includes a container and a set of dividers disposed within said container. Each divider incorporates conic spikes extending away from one or two side surfaces of the divider. The side surfaces are flat or curved. The divider also includes a set of fasteners for attaching the divider to an inner wall of the container. The spaces between the dividers are adapted to receive pet food. The pet food rests on the bottom surface of the inner wall. The dividers can be removably attached to the inner wall. The container also includes a base and an outer wall extending upward from the base. The outer wall can be slanted or straight upward. The inner wall and the outer wall merge at a top edge forming a top opening of the cavity enclosed by the inner wall.

### CROSS REFERENCE TO RELATED APPLICATIONS

This application is a continuation-in-part of U.S. patent application Ser. No. 17/225,028, entitled “HYGIENIC SLOW FEEDING BOWL,” filed Apr. 7, 2021, which is hereby incorporated by reference in its entirety.

### FIELD OF THE DISCLOSURE

The present disclosure generally relates to pet feeding devices. More particularly, the present disclosure relates to a pet feeding bowl that improves a pet's mealtime and digestion. More particularly still, the present disclosure relates to a pet feeding bowl that improves the pet's hygiene, mealtime and digestion.

### BACKGROUND

People generally love and have pets, such as dogs and cats. The pets are fed with solid food placed into feeding bowls. Some conventional pet feeding bowls are constructed with a maze to slow down the pets' feeding pace. The slowdown increases the amount of time of a pet's meal, i.e., improve the pet's mealtime. The increased feeding time helps digestion, prevents gulping, bloat and canine obesity, and promotes fun of feeding. However, the convention feeding bowls fail to provide a hygienic feature for the pets, such as a feature for keeping the pets' teeth clean. Accordingly, there is a need for an improved pet feeding device that slows down the feeding pace, promotes healthy feeding, is fun, and keeps their teeth clean.

### SUMMARY OF THE DISCLOSURE

Generally speaking, pursuant to the various embodiments, the present disclosure provides a hygienic slow feeding bowl. The hygienic slow feeding bowl includes a container in a shape of a frustum incorporating a base; an outer wall extending upward from the base and having a top edge enclosing a top opening; and an inner wall extending downward from the top edge, forming a cavity exposed by the top opening, and incorporating a set of apertures. The hygienic slow feeding bowl further includes a set of dividers disposed within the cavity and resting on a bottom surface of the inner wall, each divider within the set of dividers incorporating a set of spikes extending away from at least one flat surface of the divider, each spike within the set of spikes incorporates a conic head; and incorporating a set of fasteners extending away from a bottom surface of the divider, each fastener within the set of fasteners incorporating a neck and a head larger than the neck, the head adapted to be inserted through a corresponding fastener within the set of fasteners, the neck adapted to be disposed within a corresponding fastener within the set of fasteners, adjacent dividers within the set of dividers forming a space adapted to receive some amount of pet food. The set of dividers includes a first divider with two side surfaces and two corresponding set of spikes extending away from the two side surfaces respectively. The set of dividers includes a first divider with a single side surface from which a set of spikes extends from.

Further in accordance with the present teachings is a hygienic slow feeding bowl. The hygienic slow feeding bowl includes a container incorporating a base; an outer wall extending upward from the base and having a top edge enclosing a top opening; and an inner wall extending downward from the top edge, forming a cavity exposed by the top opening, and incorporating a set of apertures. The hygienic slow feeding bowl further includes a set of dividers adapted to be disposed within the cavity and rest on a bottom surface of the inner wall, each divider within the set of dividers incorporating a set of spikes extending away from at least one surface of the divider; and incorporating a set of fasteners extending away from a bottom surface of the divider for attaching the divider to the inner wall, adjacent dividers within the set of dividers forming a space adapted to receive some amount of pet food. Each spike within the set of spikes incorporates a conic head. The set of dividers includes a first divider with two side surfaces and two corresponding set of spikes extending away from the two side surfaces respectively. The two side surfaces of the first divider are flat or curved. The set of dividers may also include a first divider with a single side surface from which a set of spikes extends from and the single side surface is flat or curved. The container is a frustum, a cylinder or a prism. Each fastener within the set of fasteners incorporating a neck and a head larger than the neck. The head is adapted to be inserted through a corresponding fastener within the set of fasteners while the neck is adapted to be disposed within the corresponding fastener within the set of fasteners. In one implementation, the outer wall is part of the inner wall. The outer wall and the inner wall join at the top edge.

Further in accordance with the present teachings is a hygienic slow feeding bowl that includes a container incorporating a base; an outer wall extending upward from the base and having a top edge enclosing a top opening; and an inner wall extending downward from the top edge, forming a cavity exposed by the top opening, and incorporating a set of ribs. The hygienic slow feeding bowl further includes a first set of dividers adapted to be disposed within the cavity and rest on a bottom surface of the inner wall. Each divider within the first set of dividers incorporates a set of spikes extending away from each of two side surfaces of the divider; and a cavity for receiving and snuggly fit a rib within the set of ribs. Adjacent dividers within the set of dividers form a space adapted to receive some amount of pet food. Each spike within the set of spikes is in the shape of a cone or a frustum in shape. In a further embodiment, the hygienic slow feeding bowl incudes a second set of dividers. The container incorporates a set of columns; and each divider within the second set of dividers incorporates a set of spikes on a single side surface and a set of cavities for receiving and snuggly fitting the set of columns. The two side surfaces are flat or curved. The container is a frustum, a cylinder or a prism in shape. Each rib within the set of ribs incorporates a horizontal frame and two arms extending upward from the horizontal frame. Alternatively, each rib within the set of ribs incorporates a horizontal frame without an arm extending upward from the horizontal frame. The set of spikes includes a subset of long spikes and a subset of short spikes. The subset of long spikes is disposed above the subset of short spikes. In one implementation, each long spike within the subset of long spikes is longer than each short spike within the subset of short spikes.

### BRIEF DESCRIPTION OF THE DRAWINGS

Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a front perspective view of a hygienic slow feeding bowl for pets in accordance with the present disclosure.

FIG. 2 is a side cross-sectional view of a hygienic slow feeding bowl for pets in accordance with the present disclosure.

FIG. 3 is a top view of a hygienic slow feeding bowl for pets in accordance with the present disclosure.

FIG. 4A is a rear perspective view of a hygienic slow feeding bowl for pets in accordance with the present disclosure.

FIG. 4B is a side view of a fastener of a divider of a hygienic slow feeding bowl for pets in accordance with the present disclosure.

FIG. 5 is a front perspective view of a spiky pad of a hygienic slow feeding bowl for pets in accordance with the present disclosure.

FIG. 6 is a top view of a hygienic slow feeding bowl for pets in accordance with the present disclosure.

FIG. 7 is a side view of a hygienic slow feeding bowl for pets in accordance with the present disclosure.

FIG. 8 is a side view of a spike of a hygienic slow feeding bowl for pets in accordance with the present disclosure.

FIG. 9 is a front perspective view of a container of a hygienic slow feeding bowl for pets in accordance with the present disclosure.

FIG. 10 is a rear perspective view of a container of a hygienic slow feeding bowl for pets in accordance with the present disclosure.

FIG. 11 is a side view of a rib of a hygienic slow feeding bowl for pets in accordance with the present disclosure.

FIG. 12 is a side view of a rib of a hygienic slow feeding bowl for pets in accordance with the present disclosure.

FIG. 13 is a rear perspective view of a spiky divider of a hygienic slow feeding bowl for pets in accordance with the present disclosure.

FIG. 14 is a rear perspective view of a spiky divider of a hygienic slow feeding bowl for pets in accordance with the present disclosure.

FIG. 15 is a left side perspective view of a spiky divider of a hygienic slow feeding bowl for pets in accordance with the present disclosure.

### DETAILED DESCRIPTION

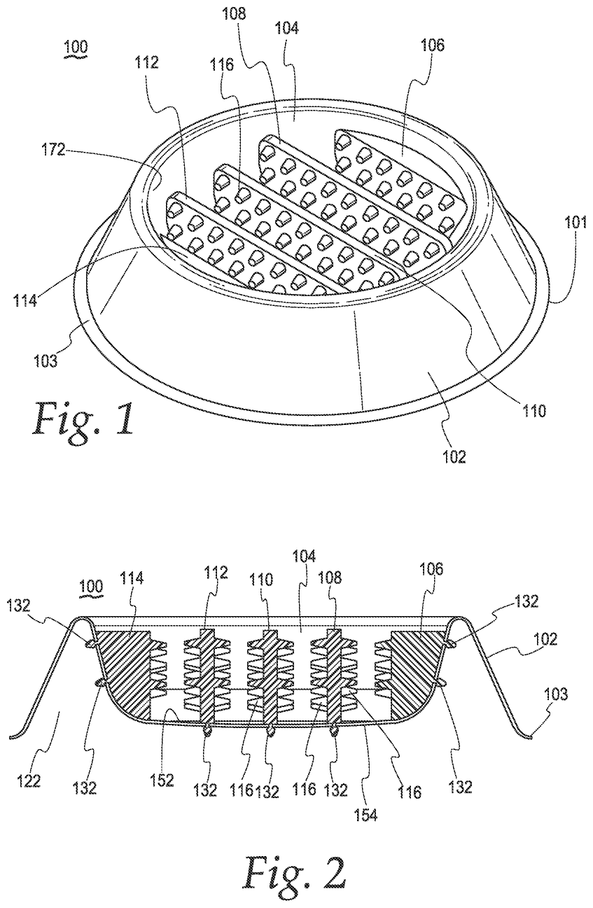

Turning to the figures, and to FIG. 1 in particular, a front perspective view of a hygienic slow feeding bowl for pets, such as dogs and cats, is shown and generally indicated at 100. The hygienic slow feeding bowl 100 incorporates a container 101 and a set of spiky dividers, such as those indicated at 106, 108, 110, 112 and 114. The spiky dividers 106-114 are removably attached to the container 101. Alternatively, the spiky dividers 106-114 are affixed to or integrally formed with the container 101. Regardless of the connection mechanism, as used herein, the dividers 106-114 are said to be attached to the container 101.

The container 101 includes an outer wall 102, a base 103 and a top opening exposing a cavity 104 of the container 101. The outer wall 102 extending upward from the base 103. In one implementation, the base 103 is the bottom edge of the outer wall 102. The cavity 104 is formed by an inner wall 172. The inner wall 172 and the outer wall 102 merge at the top to form a top edge. The top edge encloses a top opening. The inner wall 172 extends downward from the top edge of the cavity 104. In one implementation, the outer wall 102 is slanted. Accordingly, the base 103 is bigger than the top. The bigger base 103 causes the hygienic slow feeding bowl 100 to be more stable. In such a case, the container 101 is a conic frustum. Alternatively, the frustum container 101 is constructed in the shape of, such as, a square or a rectangular frustum. In the illustrative embodiment, the inner wall 172 and the outer wall 102 join at the top edge. The top edge encloses the top opening.

The dividers 106-114 are disposed inside the cavity 104. The dividers 106-114 each incorporate a plurality of spikes 116. The spikes 116 protrude away from the surfaces of the dividers 106-114 in a horizontal orientation. In one implementation, the spikes 116 is in the shape of a frustum shown in FIG. 1. Alternatively, it is conic in shape and incorporates a conic head portion, which is shown in FIG. 8 and indicated at 800. The spikes 116 are disposed on one or two side surfaces of each divider. The spikes 116 are present on both sides of each of the dividers 108-112. The spikes 116 are present on an inside surface of each of the dividers 106 and 114.

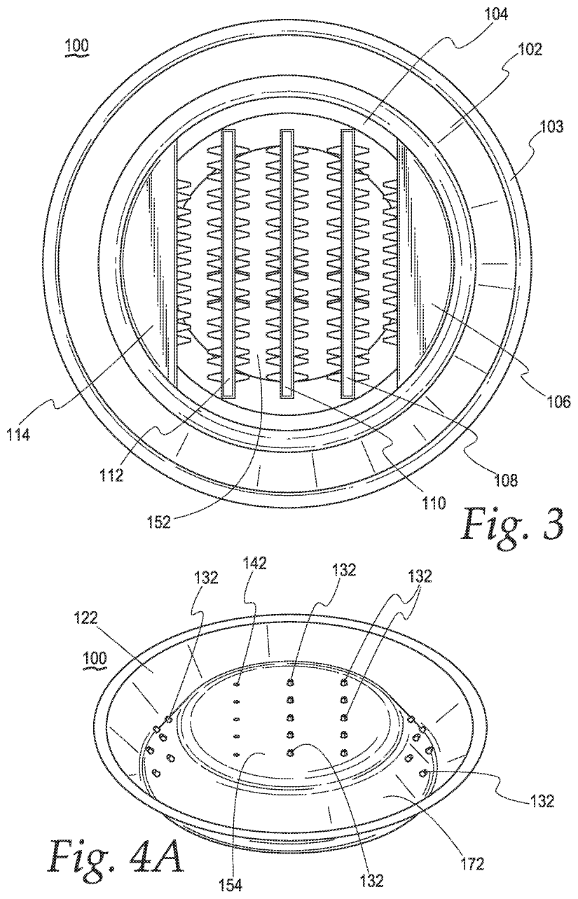

Food for a pet (such as a dog or a cat) is placed in the spaces between the dividers 106-114 and rests on the top surface 152 (indicated in FIG. 3) of the bottom portion of inner wall 172. For the pet to reach the food, it needs to insert its mouth and teeth into the spaces. The teeth then make physical contact with the spikes 116. The spikes 116 then cleans the pet's teeth. In one embodiment, the spikes 116 each incorporates the conic portion at its head end. The conic head improves the effectiveness of teeth cleaning since it pokes dirt off the pet's teeth. When the spikes 116 are constructed in a tapered shape, such as a frustum, the narrowed ends are also effective in cleaning the pet's teeth.

In one implementation, the dividers 106-114 and the spikes 116 are made of natural rubber or flexible silicone. In a different implementation, the dividers 106-114 each are made of hard plastic with a layer of silicone forming the spikes 116 and the fasteners 132 (shown in FIGS. 2, 4A and 5). It is of food grade and free of Bisphenol A (“BPA”), Polyvinyl Chloride (“PVC”) and Phthalate. With the food disposed between the dividers 106-114, the feeding is also slowed and lasts a longer time to promote healthy eating. Furthermore, it creates excitement for the pet at feeding time.

To maximize the effectiveness of cleaning, the spikes 116 on a surface of a divider are arranged in horizontal rows and vertical columns. Alternatively, they are arranged in horizontal rows and slanted columns. As yet another alternative, they are arranged in a random manner on the surface. With the cavity 104 being circular, the dividers 106 and 114 each incorporate the spikes 116 on one side with the other side fitting the inner surface of the cavity 104 snuggly.

Referring to FIG. 2, a cross-sectional view of the hygienic slow feeding bowl 100 is shown. The inner surface of the cavity 104 is indicated at 152 while the outer surface of the cavity 104 is indicated at 154. The surfaces 152-154 are also the inner and outer surfaces of the inner wall 172. The space between the surface 154 and the slanted outer wall 102 is indicated at 122. In the illustrative embodiment, the dividers 106-114 are removably attached to the container 101. In particular, the dividers 106-116 each incorporate a set of fasteners 132 extending away from its bottom surface. In one implementation, each fastener 132 incorporates a bigger head and smaller neck. When the dividers 106-114 are attached to the container 101, the heads are pushed throw apertures on the inner wall 172.

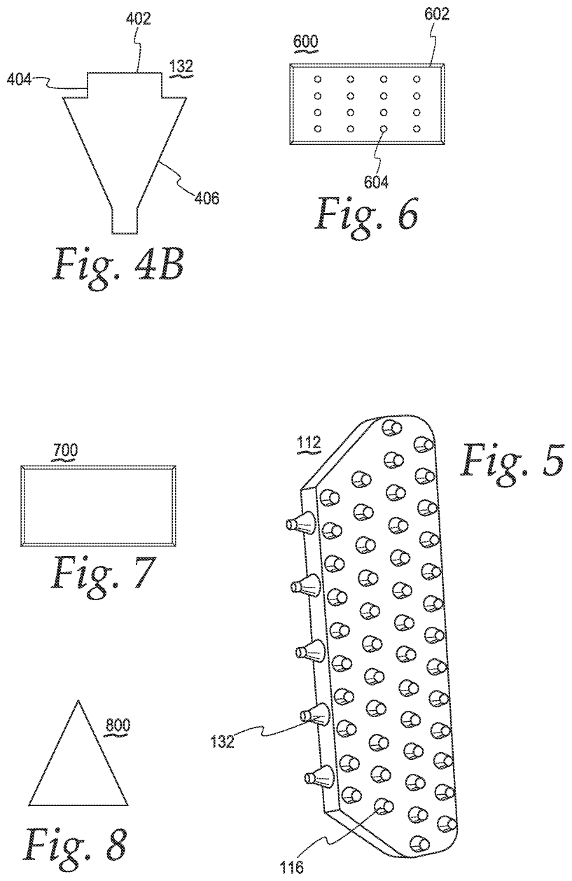

A top view of the hygienic slow feeding bowl 100 is shown in FIG. 3. FIG. 4A shows a rear perspective view of the hygienic slow feeding bowl 100. The apertures on the bottom of the cavity 104 are indicated at 142. The apertures 142 are adapted to receive the fasteners 132. A side view of the fastener 132 is shown in FIG. 4B. The fastener 132 extends from the bottom surface of a divider. The bottom of the fastener 132 is indicated at 402. The fastener 132 incorporates a narrowed neck 404 and a larger head portion 406. When a divider, such as the divider 110, is pushed against the container 101 with its fasteners' 132 tapered heads 406 aligned with the corresponding apertures 142, the heads 406 are flexible enough to be pushed through the apertures 142. Thereafter, the apertures 142 receive the corresponding fasteners' 132 smaller necks 404. Accordingly, the divider 110 is firmly attached to the container 101. When the divider 110 needs to be cleaned, it can be pulled away from the container 101. In one implementation, the dividers 106-114 are machine washable. A perspective view of a divider, such as the divider 112, is shown in FIG. 5.

The shape of the container 101 can be different from a frustum. In an alternate embodiment, the container is a prism, which is shown and generally indicated at 600 in FIG. 6. The container 600 incorporates a wall 602 and a set of apertures 604 on its bottom. The shape of the container 101 can also be in the shape of a cylinder as shown in FIG. 7 and indicated at 700.

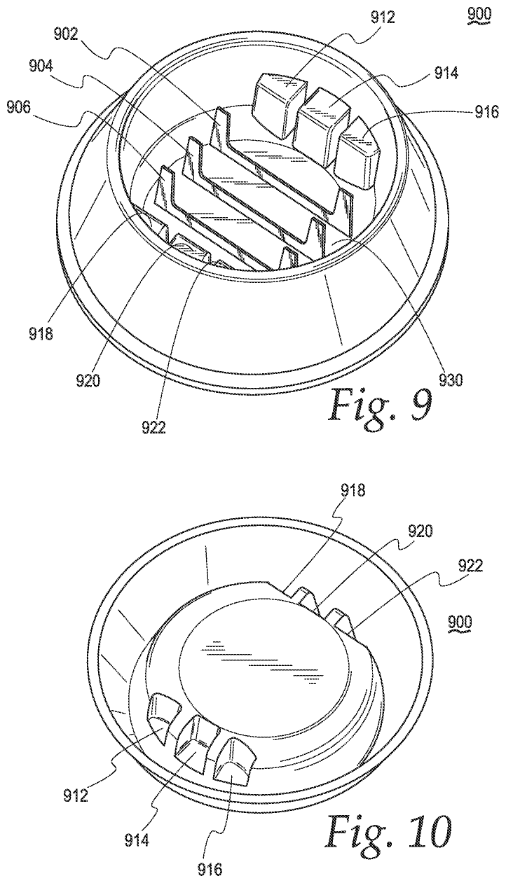

In a further implementation, the elements of the hygienic slow feeding bowl 100 incorporate different structures. In particular, the container 101 and the spiky dividers 106-114 incorporate different structures in the alternative embodiment. The different container is further illustrated by reference to FIGS. 9 and 10 while the new spiky dividers are further illustrated by reference to FIGS. 13 and 14. A front perspective view and a rear perspective view of the new container are shown in FIGS. 9 and 10 respectively and generally indicated at 900. The container 900 incorporates a set of spiky divider ribs, such as those indicated at 902, 904 and 906, extending upward from the top surface 930 of the bottom of the container 900. The ribs 902-906 can be integrally formed with the container 900. Alternatively, they are mounted to the container 900 by, for example, welding or glue. As used herein, the inner wall 172 is said to incorporate the set of ribs 902-906.

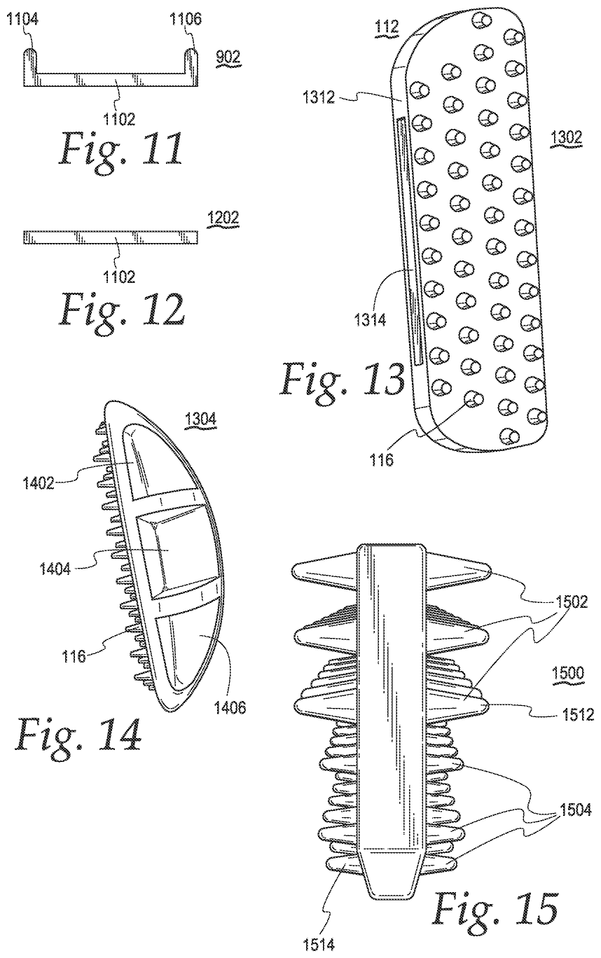

The ribs 902-906 are further illustrated by reference to FIG. 11. Referring to FIG. 11, a side view of the rib 902 is shown. The rib 902 incorporates a horizontal frame 1102 and two end arms 1104 and 1106 extend upward from the frame 1102. In one implementation, the height of the frame 1102 is about 1.5 centimeters and the thickness of it is about 3 millimeters, while the arms 1104-1106 are each about 1 centimeter above the frame 1102. In an alternate embodiment, the ribs do not incorporate the arms 1104-1106. A side view of the alternative embodiment of the ribs are shown in FIG. 12 and generally indicated at 1202.

Turning back to FIG. 9, the container 900 further incorporate a set of columns, such as those indicated at 912, 914, 916, 918, 920 and 922. In the illustrative embodiment, the subset of columns 912-916 and the subsets of columns 918-922 are disposed on opposite sides of the container 900. The set of columns 912-922 is further shown in FIG. 10 as indentation from the rear side of the container 900.

Referring now to FIGS. 13 and 14, perspective views of the new embodiments of the spiky dividers 108 and 106 are shown and generally indicated at 1302 and 1304 respectively. In the alternate embodiment, the replacement dividers of the dividers 108-112 incorporate the structure of the new spiky divider 1302, while the replacement dividers of the side dividers 106 and 114 incorporate the structure of the new spiky divider 1304. The divider 1302 incorporates a set of spikes 116 on both sides, while the divider 1304 incorporates a set of spikes 116 on only one side.

The spiky divider 1302 further incorporates a cavity 1314 exposed by the bottom surface 1312 of the spiky divider 1302. The cavity 1314 is constructed to receive a rib, such as the rib 902, 904 or 906. The rib 902 snuggly fits inside the cavity 1314. The cavity 1314 snuggly fits the frame 1102 and the arms 1104-1106. The arms 1104-1106 provide enhanced firmness of attachment between the divider 1302 and the rib 902.

When the arms 1104-1106 are not present, the cavity 1314 does not have to incorporate portions for receiving the arms 1104-1106. To install the spiky divider 1302 on to the container 900, a user aligns the cavity 1314 with one of the set of ribs 902-906 and push it downward against the rib. When to remove the spiky divider 1302 from the container 900, the user then pulls the spiky divider 1302 away from the container 900.

Turning to FIG. 14, the spiky divider 1304 incorporates a set of cavities, such as those indicated at 1402, 1404 and 1406, corresponding to a set of columns, such as the subset columns 912-916. The set of cavities 1402-1406 are constructed to receive and snuggly fit the set of columns 912-916.

An alternate embodiment of the spiky divider 1302 is further illustrated by reference to FIG. 15. Referring to FIG. 15, a left side perspective view of the alternate embodiment I shown and generally indicated at 1500. The spiky divider 1500 incorporates spikes of different lengths. In one illustrative embodiment, the spiky divider 1500 incorporates a subset of spikes 1512 with a bigger length and a second subset of spikes 1514 with a smaller length. The spike 1512 is longer than the spike 1514. In the illustrative implementation, the spiky divider 1500 includes three rows of the long spikes 1512 that are indicated at 1502, and three rows of the short spikes 1514 that are indicated at 1504. The subset of long spikes 1502 are disposed above the subset of short spike 1504. The short spikes 1504 allows the container 900 to store more pet food in its lower portion.

Obviously, many additional modifications and variations of the present disclosure are possible in light of the above teachings. Thus, it is to be understood that, within the scope of the appended claims, the disclosure may be practiced otherwise than is specifically described above. In the illustrative embodiment, the dividers 108-112 each incorporate two flat side surfaces from which the spikes 116 extend from. They further vertically rest on the bottom of the cavity 104. Alternatively, the dividers 108-112 incorporate one or two curved side surfaces. As yet another alternative, the outer wall 102 and the inner wall 172 are the same wall. As still another example, the container, the spiky dividers and the spikes are integrally formed.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification, but be defined by the claims set forth below. In addition, although narrow claims may be presented below, it should be recognized that the scope of this invention is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional inventions are not dedicated to the public and the right to file one or more applications to claim such additional inventions is reserved.

What is claimed is:

1. A hygienic slow feeding bowl comprising:
a) a container in a shape of a frustum incorporating:
i. a base;
ii. an outer wall extending upward from said base and having a top edge enclosing a top opening; and
iii. an inner wall extending downward from said top edge, forming a cavity exposed by said top opening, and incorporating a set of apertures; and
b) a set of dividers disposed within said cavity and resting on a bottom surface of said inner wall, each divider within said set of dividers:
i. incorporating a set of spikes extending away from at least one flat surface of said divider, each spike within said set of spikes is a cone or frustum in shape; and
ii. incorporating a set of fasteners extending away from a bottom surface of said divider, each fastener within said set of fasteners incorporating a neck and a head larger than said neck, said head adapted to be inserted through a corresponding fastener within said set of fasteners, said neck adapted to be disposed within a corresponding fastener within said set of fasteners, adjacent dividers within said set of dividers forming a space adapted to receive some amount of pet food.

2. The hygienic slow feeding bowl of claim 1 wherein said set of dividers includes a first divider with two side surfaces and two corresponding set of spikes extending away from said two side surfaces respectively.

3. The hygienic slow feeding bowl of claim 1 wherein said set of dividers includes a first divider with a single side surface from which a set of spikes extends from.

4. A hygienic slow feeding bowl comprising:
a) a container incorporating:
i. a base;
ii. an outer wall extending upward from said base and having a top edge enclosing a top opening; and
iii. an inner wall extending downward from said top edge, forming a cavity exposed by said top opening, and incorporating a set of apertures; and
b) a set of dividers adapted to be disposed within said cavity and rest on a bottom surface of said inner wall, each divider within said set of dividers:
i. incorporating a set of spikes extending away from at least one surface of said divider; and
ii. incorporating a set of fasteners extending away from a bottom surface of said divider for attaching said divider to said inner wall, adjacent dividers within said set of dividers forming a space adapted to receive some amount of pet food.

5. The hygienic slow feeding bowl of claim 4 wherein each spike within said set of spikes is in the shape of a cone or a frustum in shape.

6. The hygienic slow feeding bowl of claim 4 wherein said set of dividers includes a first divider with two side surfaces and two corresponding set of spikes extending away from said two side surfaces respectively.

7. The hygienic slow feeding bowl of claim 6 wherein said two side surfaces of said first divider are flat or curved.

8. The hygienic slow feeding bowl of claim 4 wherein said set of dividers includes a first divider with a single side surface from which a set of spikes extends from.

9. The hygienic slow feeding bowl of claim 8 wherein said single side surface is flat or curved.

10. The hygienic slow feeding bowl of claim 4 wherein said container is a frustum, a cylinder or a prism in shape.

11. The hygienic slow feeding bowl of claim 4 wherein each fastener within said set of fasteners incorporating a neck and a head larger than said neck, said head adapted to be inserted through a corresponding fastener within said set of fasteners, said neck adapted to be disposed within said corresponding fastener within said set of fasteners.

12. A hygienic slow feeding bowl comprising:
a) a container incorporating:
i. a base;
ii. an outer wall extending upward from said base and having a top edge enclosing a top opening; and
iii. an inner wall extending downward from said top edge, forming a cavity exposed by said top opening, and incorporating a set of ribs; and
b) a first set of dividers adapted to be disposed within said cavity and rest on a bottom surface of said inner wall, each divider within said first set of dividers:
i. incorporating a set of spikes extending away from each of two side surfaces of said divider; and
ii. incorporating a cavity for receiving and snuggly fit a rib within said set of ribs, adjacent dividers within said set of dividers forming a space adapted to receive some amount of pet food.

13. The hygienic slow feeding bowl of claim 12 wherein each spike within said set of spikes is in the shape of a cone or a frustum in shape.

14. The hygienic slow feeding bowl of claim 12 further comprising a second set of dividers, wherein:
a) said container incorporates a set of columns; and
b) each divider within said second set of dividers incorporates a set of spikes on a single side surface and a set of cavities for receiving and snuggly fitting said set of columns.

15. The hygienic slow feeding bowl of claim 12 wherein said two side surfaces are flat or curved.

16. The hygienic slow feeding bowl of claim 12 wherein said container is a frustum, a cylinder or a prism in shape.

17. The hygienic slow feeding bowl of claim 12 wherein each rib within said set of ribs incorporates a horizontal frame and two arms extending upward from said horizontal frame.

18. The hygienic slow feeding bowl of claim 12 wherein each rib within said set of ribs incorporates a horizontal frame without an arm extending upward from said horizontal frame.

19. The hygienic slow feeding bowl of claim 12 wherein said set of spikes includes a subset of long spikes and a subset of short spikes, wherein said subset of long spikes is disposed above said subset of short spikes.

20. The hygienic slow feeding bowl of claim 19 wherein each long spike within said subset of long spikes is longer than each short spike within said subset of short spikes.
